(19) United States
(12) Patent Application Publication
(10) Pub. No.: US 2008/0226781 A1
(43) Pub. Date: Sep. 18, 2008

(54) Method of Obtaining Vegetable Proteins and/or Peptides, Proteins Produced According to Said Method and/or Peptides and Use Thereof

(75) Inventors: Martin Lotz, Emlichheim (DE); Gerold Eggengoor, Wilsum (DE)

Correspondence Address: MILLER, MATTHIAS & HULL, ONE NORTH FRANKLIN STREET, SUITE 2350, CHICAGO, IL, 60606, US

(73) Assignee: EMSLAND-STARKE GMBH, Emlichheim (DE)

(21) Appl. No.: 12/045,357

(22) Filed: Mar. 10, 2008

(30) Foreign Application Priority Data
Mar. 15, 2007 (DE) 102007012439 4-41

(51) Int. Cl. A23J 3/14

(52) U.S. Cl. 426/271

(57) ABSTRACT

A method of obtaining vegetable proteins and/or peptides is disclosed that includes the steps of: a) preparing a vegetable starting material containing proteins and/or peptides in an aqueous matrix; b) optionally eliminating solid components from said aqueous matrix and/or clarifying said aqueous matrix; c) isolating the proteins and/or peptides from the aqueous matrix by adsorption on at least one ion exchanger membrane made of a synthetic polymer; d) optionally rinsing the ion exchanger membrane in order to remove impurities; e) desorbing the proteins and/or peptides from the ion exchanger membrane with at least one eluent; f) isolating the proteins and/or peptides from the eluent; and g) optionally drying the isolated proteins and/or peptides; and a protein, peptide and/or mixtures thereof prepared in accordance with the method, and uses thereof.

### FIELD OF THE DISCLOSURE

The present disclosure relates to a method of obtaining vegetable proteins and/or peptides, proteins produced according to said method and/of peptides and mixtures thereof, and use thereof.

### BACKGROUND OF THE DISCLOSURE

Both animal and vegetable proteins are known for human consumption. Animal proteins, such as chicken proteins, and milk proteins, such as casein or whey, may, however, involve problems with regard to BSE, bird flu and other diseases Animal proteins are frequently also linked to the triggering of allergies, even if these, such as in the case of a lactose intolerance, are not themselves based on the protein.

Vegetable proteins involve problems with genetically modified organisms (GMO), their nutritional value and likewise with the triggering of allergies. The best-known vegetable protein is soya protein. A further point is that vegetable proteins fiequently involve the problem of taste, such as in the case of soya, so that the possibility of using them in foodstuffs is severely restricted. Similarly, the use of other vegetable proteins, such as those from rapeseed, lupins or potatoes, has not become wide-spread so far. In the case of rapeseed and legumes, the reason for this might be that especially the fat content of these starting materials leads to rancidness.

From the chemical point of view, the protein content of standard commercial products, which also contain many other desirable and undesirable substances, consists of many separate protein and peptide molecules, which can first of all be roughly subdivided phenomenologically into globulins and albumins. Globulins are spherical in shape, rendering them quite compact and insoluble in water, or at least poorly soluble Albumins are open, more irregular in shape and are therefore soluble in water. The soluble proteins are generally subsumed under albumins. In addition, standard commercial protein naturally also consists of protein and peptide molecules, with varying molecular weights This makes them quite complicated to handle, e.g. from the point of view of food technology, and a health assessment can only be carried out on the basis of the amino acid spectrum.

One feature common to the standard commercial proteins is thus that they consist of a mixture of different protein and peptide molecules and that, in addition, they contain components foreign to the protein, which come from the original vegetable starting material. These include, for example, glucosides, toxins (glycoalkaloids, trypsin inhibitors, etc.), antinutritive substances, such as phytic acid, which remove calcium and iron minerals from the scope of human and animal digestion, since they are eliminated and cannot be absorbed in the intestinal tract. Also included are fats and oils, some of which are chemically bound to lipoproteins, and minerals.

So far, there are not many pure proteins or peptides, such as for healthy nutrition or as over-the-counter pharmaceuticals, which are inexpensive enough to find broader application. The reason is in particular that expensive processing methods, taken from the pharmaceutical industry, are used A further reason for the high price and extremely limited availability is the provenance of the protein molecules, which are obtained from mammals or human secretions, e.g. blood serum, all of which contain the desired action proteins in a low concentration and are themselves only available in limited quantities.

US 2003113829, US 2003092151, US 2003092152, US 2003092150 and US 2003077265 describe for the first time how individual groups of proteins can be isolated in a relatively pure form from a mixture of proteins from a vegetable raw material, in this case the potato.

They also describe the choice of raw materials; the method of eliminating Kunitz, Bowman-Birk and carboxypeptidase inhibitors from potato protein by heating, cooling, centrifuging and filtering potato juice; extending the method by using an acid extraction agent together with pulverisation of the vegetable material in the extraction solution, so that protease inhibitor II is obtained; methods of controlling the yield and purity of protease inhibitor II during extraction by leaching out potato chips, heating the extraction solution, monitoring the temperature, time and salt concentration, centrifugation and membrane filtration; isolation and purification of protease inhibitors II in a variant of the process.

One disadvantage in the known processes, however, is that while individual proteins or at least narrowly defined groups of proteins are prepared, these processes are nevertheless extremely complex, time-consuming, laborious and expensive. Another disadvantage can be seen in the need to make a special selection of the potatoes. As a result, not only the availability of the raw material is limited, but, because of the need for analytical control, an additional, complex, time-consuming and expensive intermediate step is necessary. Furthermore, the logistics are complex and time-consuming, since the potatoes have to be processed flesh and not stored. Also, the proteins can be damaged in the known processes, since large amounts of thermal energy axe needed, because processing takes place in a diluted extraction solution, and a high temperature has to be maintained for a long period of time, which makes large containers necessary in addition. Similarly, in a later step, additional energy is needed, because the amount of material to be processed has to be cooled down to approximately room temperature for the further process steps. Organic acids are needed for the extraction, which place a burden on the environment in the effluent. In addition, the vegetable material has to be laboriously chopped into particles about 100 μm to 1,500 μm in size. After the extraction and also after the heating stage, steps are necessary to separate the solids, in order to eliminate coagulated or insoluble vegetable material from the protein solution and to carry out the final isolation stage of ultrafiltration. The known methods ultimately yield only very few proteins, above all ones which are not denatured after being exposed to the effects of beat at 100° C. over a period of about 3 hours. Finally, the known methods mainly only yield proteins which satisfy the above-mentioned criteria, i.e. protease inhibitor II and carboxypeptidase inhibitors.

### SUMMARY OF THE DISCLOSURE

The present disclosure is based on the problem of providing a method of obtaining vegetable proteins and/or peptides with which the disadvantages of the prior art can be overcome. Similarly, a method is disclosed herein which makes it possible to obtain vegetable proteins and/or peptides on a broader raw material basis (i.e. it can be used not only to obtain them from potatoes, but from protein-containing plants in general). In particular, it is intended that it should be possible to carry out the method in a manner that has a low impact on the environment, does not consume much energy, and is simple and inexpensive, obtaining any proteins and peptides in the process, pure or in mixtures, without any limitations imposed by the method itself.

Other problems consist in providing proteins and/or peptides prepared in accordance with the method and in specifying possible uses.

It has surprisingly been found that the method disclosed herein, in contrast to the prior art method, manages completely without any additional chopping of the plants, heating and cooling steps, and extraction with organic additives. In particular, the selection of proteins and peptides to be obtained is not limited. The targeted selection of particular proteins and/or peptides can be achieved by controlling the method for selection purposes, by setting precise process parameters. As a result of the method, either pure proteins without any proportion of foreign proteins, or any extensive mixtures of proteins can be obtained, which behave similarly during the adsorption process. The purity of the proteins can therefore be adjusted at will by the desorption step, e.g. in the form of a dialysis step. This can be advantageous, especially when the quality of a pre-product is sufficient for medicinal applications and only the final making up must be carried out under sterile GMP conditions, which the operator of the method cannot or does not wish to satisfy.

In other words, with the methods disclosed herein, the fractionation of the proteins and/or peptides of the vegetable starting material into individual proteins or peptides or small groups of similar proteins can be achieved with extremely mild processing steps, and yet it is still possible to yield a very wide variety of products, and no expensive or complicated process steps are necessary.

One particular benefit that has become apparent is that, in accordance with this disclosure, the ion exchanger groups are immobilised on a membrane instead of polymer beads. The use of ion exchanger membranes leads to a high flow rate, no or little fouling, and extremely rapid loading, since no diffusion is necessary, a reduced consumption of chemicals for the buffer solution and eluents, case of handling and simple up-scaling, and the possibility of switching anion and cation exchangers together, since they are bound to different membranes.

In particular, it is possible with the methods disclosed herein to use only one ion exchanger membrane, which may be a cation or anion exchanger membrane. It goes without saying that combinations of anion and cation exchanger membranes may also be used. These may each be weakly or strongly acidic or alkaline in any combination. It is conceivable that a plurality of cation exchanger membranes and/or a plurality of anion exchanger membranes may be switched in series or parallel. It is, however, likewise conceivable to have all the cation exchanger membranes and all the anion exchanger membranes switched in series, while the two groups are then switched in parallel. The reverse approach is also conceivable, with cation exchanger membranes and anion exchanger membranes switched in parallel in their respective groups, while the two groups are then switched in series. This means that all conceivable variations are possible according to the methods disclosed herein and therefore are included in the scope of this disclosure.

Other advantages of binding the ion exchanger groups to a membrane are as follows:
A high charge density allows packing in small volumes, which means lower costs than, for example, immobilising on porous polymer beads, which are placed on a perforated plate in a container, where the material flows round them
No capillary diffusion and no Fick's diffusion ate needed for the molecules to be adsorbed to reach the ion exchanger molecules, as is the case, for example, with porous polymer beads made from synthetic or natural polymers. All that takes place is convection, since the loading solution flows directly over the membrane with the charge carriers. As a result, the adsorption process is considerably quicker. In circulation operation, it is possible to pass the membranes and pores with the charge carriers several times, which substantially accelerates the adsorption process and also the desorption process. The adsorber membranes can be reused several times and are easy to clean
The pore width of the membrane can be adjusted at will between normal filtration, microfiltration, ultrafiltration and nanofiltration, depending on the characteristics of the fluid and the substances to be treated and adsorbed. No blocking or clogging as in the case of the pores of polymer beads of ion exchanger resins is therefore possible
There are many different synthetic membrane materials available, with an almost unlimited choice, which makes it possible to adjust the process parameter combinations of pressure (transmembrane), temperature and pH over a wide range
The structure of the modules into which the membranes are made up and which determine the technical structure of the membrane process, can be adapted to the method: plate, cross-flow or coil modules The selection can be made, inter alia, with regard to the viscosity of the solid remaining on the membranes. If that is low, it is preerable to use a module of the coil construction type, in which a large membrane area can be installed in a small volume, so that it is therefore the most inexpensive module type.
The modules can be operated in batch or circulating mode In the first case, only the same amount of loading solution can be pumped in as emerges from the system as permeate. If the permeate flow stops, the retentate must be removed from the membranes, e.g. by rinsing. In the circulating mode, the loading solution runs between the module and a storage container in the circuit, so that the loading solution can be passed across the membranes several times. The solid contained in the retentate is withdrawn from the storage container continuously, so that there is a stationary situation in the modules between two cleaning cycles.

### BRIEF DESCRIPTION OF THE DRAWING

For a more complete understanding of this disclosure, reference should be made to the embodiments illustrated in greater detail on the accompanying drawing, wherein:

FIG. 1 is a graphical representation of an SDS-PAGE on a gel basis showing the entire proteins in potato juice before processing according to this disclosure, and the proteins and protein fractions obtained according to the methods disclosed herein.

It should be understood that the drawing is not necessarily to scale and that the disclosed embodiments are sometimes illustrated diagrammatical and in partial views. In certain instances, details which are not necessary for an understanding of this disclosure or which tender other details difficult to perceive may have been omitted. It should be understood, of course, that this disclosure is not limited to the particular embodiments illustrated herein.

### DETAILED DESCRIPTION

In the following, the individual process steps of the method according to this disclosure will be described with regard to a preferred embodiment, though without wishing to limit the subject matter of the present application to that.

The method of obtaining vegetable proteins and/or peptides according to this disclosure will be described with regard to potatoes as the vegetable starting material. Of the approximately 2,000 varieties of potato available throughout the world, about 50 varieties are suitable for obtaining starch, since they contain a disproportionately large amount of starch, 17 to 22% by weight as a rule. In principle, however, any potato variety is suitable for obtaining proteins and peptides in accordance with the methods disclosed herein.

After the potatoes have been cleaned, the first process step in obtaining starch is for the potatoes to be ground into a fine pulp. Next, the potato juice (potato fruit water), which contains the protein and/or peptide, is separated from the solids, starch and fibres in that pulp. The starch and fibres can be separated, for example, by centrifugation or in hydrocyclones. The potato juice obtained contains about 20 g/L potato proteins, about 40% of which are patatin, a major storage protein which is one of the glycoproteins, about 50% are protease inhibitors (PI), and 10% are high-molecular-weight proteins, which include the polyphenol oxidases, kinases and phosphorylases. The patatin has a molecular weight of 40 to 44 kDa and consists of 363 amino acids. At a pH of 7 to 9, it forms a dimer with a size of 80 to 88 kDa. The PI are a heterogeneous class with seven sub-classes of different proteins. Their function in the potato is protein degradation, and so they play a central role in defending the tuber against microbial pests and insects. The prevention of protein degradation has been observed in the animal model as growth inhibition; an anticarcinogenic effect is under discussion, and the promotion of the feeling of satiety by PI II is in some cases being advertised commercially. The main classes of PI are PI I, PI II, potato cystein PI (PCPI), Kunitz PI (PKPI), carboxypeptidase (PCI), serine PI (OSPI) and potato aspartyl PI (PAPI).

The potato juice obtained is then clarified in a microfiltration membrane device. In the process, the pore width of the membranes can be chosen at will and can be adapted to the desired products to be obtained Clarification of the potato juice obtained is also possible by means of centrifuges of any type, for example, provided a clear centrifugate containing exclusively dissolved components is obtained. These and all the following steps, with the exception of drying in step g), are carried out at a temperature below the coagulation temperature or denaturing temperature of the proteins and/or peptides, preferably at a temperature of less than 30° C.

The methods disclosed herein include isolating the proteins and/or peptides from the aqueous matrix, in this case the potato juice, by adsorption on at least one ion exchanger membrane made from a synthetic polymer Examples of such membranes are commercially obtainable under the name Sartobind® from the Sartorius company.

It is possible that in step c) only part of the proteins and/or peptides are isolated from the aqueous matrix by adsorption. This is closely connected with the cation or anion exchanger membranes used. It is likewise conceivable that some of the proteins and/or peptides which are not wanted or needed for more precise separation may already be separated before step c) by denaturing/coagulation. Denaturing/coagulation can be carried out, for example, by shifting the pH, using organic solvents or salting out.

Similarly important is the targeted desorption of the proteins and/or peptides bound to the ion exchanger membrane by means of specially adapted eluents, after remnants of the potato juice have previously been optionally rinsed off the membrane.

In order to immobilise anionic proteins, ion exchanger membranes with cationic groups, such as with trimethyl groups, can be used, whereas for cationic proteins, anionic groups, such as sulphomethyl groups, should be present in the ion exchanger membrane.

In order to provide mechanical protection for the adsorber membrane, and also in order to extend its service life, it is advisable, as a preliminary step, to eliminate solids and suspended or dispersed particles, as mentioned above. This can be done by a centrifuge or by filtration, the latter in standard pore sizes going as far as microfiltration. The use of microfiltration with a suitable pore size of 0.2 μm has the advantage of allowing all proteins to pass through, but at the same time it likewise removes any microorganisms also present in the protein-containing solution, thus making the medium sterilised. After that, the proteins and/oi peptides are adsorbed on the membranes by pumping the filtrate, permeate or clarified protein solution in the membrane adsorber module. In this context, a wide range of process variants are possible. First of all, the cation and anion exchanger membrane modules can be switched parallel or in series. The adsorber membranes can be made up in plate, cross-flow or coil module systems. The protein-containing loading solution can be delivered in the dead-end process or in the circulating process. The former is inevitably a batch process, while the latter can be performed both in batches and continuously. The pore width of the adsorber membrane can be selected at will, though it is advisable for it not to be smaller than the pores of the prefiltration stage, since there is otherwise a risk of material building up on the adsorbers in the form of a retentate, which subsequently has to be removed in the rinsing step in addition, and, since it consists of potential product, this also means a loss of yield. When the adsorber membranes are completely charged with protein molecules, which can easily be determined analytically, for example by measuring the conductivity in the outflow from the membranes or, in dead-end operation, in the permeate itself, the supply of loading solution is interrupted, and the membranes can optionally be purged in order to remove impurities. Purging can also be effected with water or a cleaning solution, but the latter should not denature the proteins.

The products adhering to the membranes can then, as in a conventional chromatography process, be selectively desorbed with one or more eluents. This is preferably done with a salt solution, the composition and concentration of which depends on the proteins and peptides to be eluted. Typically, sodium chloride and ammonium chloride solutions are used, though the selection here is virtually unlimited and is determined by the characteristics of the proteins. It is also possible to add buffer salts or buffer solutions, e.g. phosphate buffer, So that the eluted proteins do not denature, they should only be present in a low concentration in the eluent. A concentration step before drying is therefore advantageous. Furthermore, the purity of the proteins isolated in this way can be adjusted at will by rinsing with distilled water or tap water. If an ultrafiltration membrane in a plate, cross-flow or coil module system in circulating mode is used for these two process steps, the filtration and concentration can be performed simultaneously in this case, for example by constantly topping up an amount of rinsing water in the storage container which is no more than the permeate passing through the pores of the ultrafiltration membrane. The purity can be monitored effectively by measuring the electrical conductivity in the permeate.

In the next process step, the product is isolated from the eluent, for example by drying or separating the eluent and the protein molecules on a membrane with a suitable pore width, which will preferably extend to the range of ultrafiltration or nanofiltration, and even to reverse osmosis, diafiltering and concentrating or only concentrating or only diafiltering.

As the final step, drying optionally follows, it being advantageous to use gentle freeze-drying or spray-drying. Other types of drying are likewise possible, though an intensive heating effect should be avoided, since this could result in damage being done to the product.

The following examples further illustrate the methods disclosed herein in greater detail.

### EXAMPLE 1

An anion exchanger module with a surface area of 80 m² with a binding capacity of 0.4 mg protein/cm² can bind 320 g protein 50% of the proteins in potato juice are PI, which is about 10 g/l After 32 l of potato juice have been applied, the capacity is then exhausted. With a typical flow rate of 300 l/h, this takes about 6.5 minutes. After that, the PI proteins can be eluted.

### EXAMPLE 2

A cation exchanger module with a surface area of 80 m² with a binding capacity of 0.25 mg protein/cm² can bind 200 g protein 40% of the proteins in potato juice are patatin, which is about 8 g/13.3 m² membrane are needed for the complete binding of the patatin from 1 l of potato juice. On 330 m², 1 kg patatin from 125 l juice can therefore be adsorbed. After that, the patatin can be eluted.

### EXAMPLE 3

One major advantage of the disclosed methods is the possibility of re-using both the membrane adsorber and the rinsing solution and the eluent.

A cation exchanger module with a surface area of 15 cm² is loaded with 1.5 ml of a BSA solution (BSA=bovine serum albumin) with a concentration of 10 mg/ml This is slightly below the maximum loading of about 20 mg. The scheme for identifying long-term stability is carried out by loading, rinsing, eluting and rinsing. The rinsing liquid is a 50 mM potassium phosphate buffer at pH 7, and the eluent is a 1M NaCl solution in the same buffer. A cycle takes 21.5 minutes. In the course of time, it lies in the nature of things that the elution peaks become wider, and up to 65 cycles are possible, without clogging the membrane, and without any rupture occurring. If the rinsing step is extended by 5 minutes, more than 100 cycles without membrane cleaning are possible. Clogging occurs as of the 108th cycle After cleaning with 0.5 M sodium hydroxide solution, the membrane was free again, so that it was possible to restart the production process. In this way, several thousand cycles are possible with one adsorber module before it is worn.

### EXAMPLE 4

One disadvantage is the high consumption of water and salt when rinsing and eluting Re-using the solutions several times is therefore very advantageous. The eluate after one cycle and loading with 0.4 mg protein/ml was re-used for elution, and the loading was now 0.86 mg/ml. After the fourth elution, the concentration rose to 1.2 mg/ml. The saving of eluents (water, salt and buffer) is thus 75%.

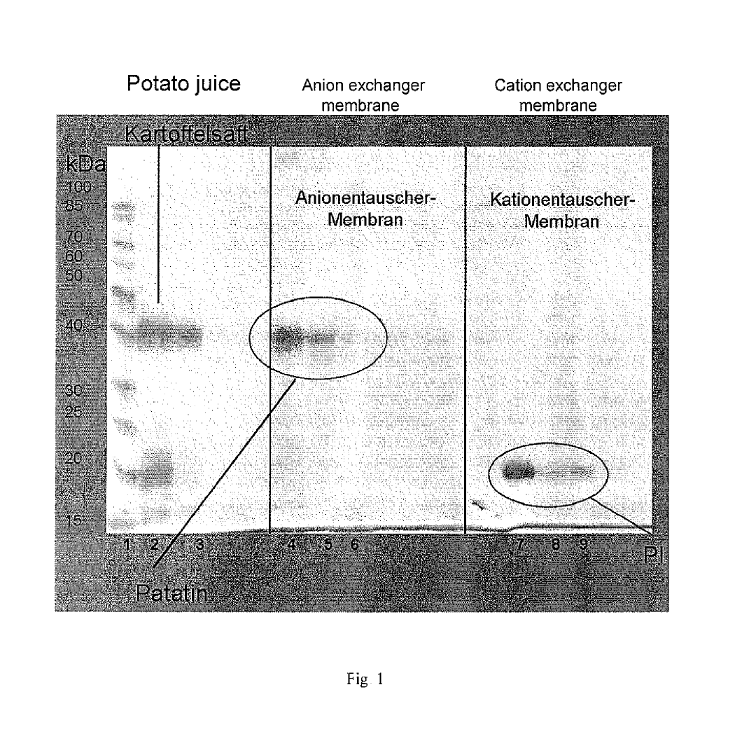

The enclosed FIG. 1 shows SDS-PAGE on a gel basis with the representation of the entire proteins in potato juice before processing according to the methods disclosed herein, and the proteins and protein fractions obtained according to those methods which are immobilised on the cation and anion exchanger adsorber membranes and eluted again.

As can be seen from FIG. 1, it was possible to achieve the targeted isolation of patatin via the anion exchanger membrane and PI via the cation exchanger membrane and to separate them in substantially pure form, which once again impressively demonstrates the advantages of the methods disclosed herein.

The proteins and/or peptides obtained by the methods disclosed herein can be used, for example, in functional foodstuffs, i.e. foodstuffs with a positive physiological effect. They can also be used to combat and prevent disease and to improve performance and the sense of well-being. One preferred use of the proteins and/peptides may be in a pharmaceutical form, such as in capsule form. In this case, the protease inhibitor II is particularly interesting, since its appetite-suppressing effect is known and it can easily be packed in a hard gel capsule, for example.

While such embodiments have been set forth, alternatives and modifications will be apparent in the above description to those skilled in the art. These and other alternatives are considered equivalents in the spirit and scope of this disclosure and the appended claims.

What is claimed is:

1. A method of obtaining vegetable proteins and/or peptides, comprising the steps of:
a) preparing a starting material containing vegetable proteins and/or peptides in an aqueous matrix;
b) optionally eliminating solid components from said aqueous matrix and/or clarifying said aqueous matrix;
c) isolating at least part of the proteins and/or peptides from the aqueous matrix by adsorption on at least one ion exchanger membrane made of a synthetic polymer;
d) optionally rinsing the ion exchanger membrane in order to remove impurities;
e) desorbing the proteins and/or peptides from the ion exchanger membrane with at least one eluent;
f) isolating the proteins and/or peptides from the eluent; and
g) optionally drying the isolated proteins and/or peptides.

2. The method of claim 1, in which the aqueous matrix is obtained by grinding the vegetable starting material to a pulp or milling starting materials, especially dry ones, into a flour and swelling in water and eliminating solid components.

3. The method of claim 2, in which the solid components comprise starch and fibres from the vegetable starting material.

4. The method of claim 1, in which the starting material is selected from protein-containing plants, preferably potatoes, legumes, soya, rapeseed and mixtures thereof, particularly preferably potatoes.

5. The method of claim 4, in which the legumes are selected from peas, beans, lupins, soya and mixtures thereof.

6. The method of claim 1, in which the clarification in step b) is performed in a microfiltration membrane apparatus.

7. The method of claim 1, in which at least steps a)-f) are carried out at a temperature below the coagulation or denaturing temperature of the proteins and/or peptides, preferably at a temperature of less than 30° C.

8. The method of claim 1, in which steps c) and/or e) is/are operated in a batch or circulating process.

9. The method of claim 1, in which at least one cation exchanger membrane and at least one anion exchanger membrane are used in step c).

10. The method of claim 9, in which the cation exchanger membrane and the anion exchanger membrane are operated in parallel or in series.

11. The method of claim 1, in which each ion exchanger membrane is present in an absorber module, preferably a plate, cross-flow or coil module.

12. The method of claim 1, in which a pore width of the ion exchanger membrane is adjusted in order to achieve microfiltration, ultrafiltration or nanofiltration.

13. The method of claim 1, in which the desorption of individual proteins and/or peptides or groups thereof in step e) is performed successively and selectively using a number of different eluents.

14. The method of claim 1, in which the eluent is selected from an aqueous salt solution, preferably a sodium chloride and ammonium chloride solution.

15. The method of claim 1, in which the isolation in step f) is performed by membrane filtration or drying.

16. The method of claim 1, in which the drying in step g) is performed by spray-drying or freeze-drying.

17. The method of claim 1, further comprising, prior to step c), precipitating and removing some of the proteins and/or peptides from the aqueous matrix by denaturing/coagulation.

18. The method of claim 17, in which the denaturing/coagulation is effected by shifting pH, or by using organic solvents or by salting out.

19. A protein, peptide and/or mixtures thereof, obtained by a method according to claim 1.

20. Use of the protein, peptide and/or mixtures thereof obtained from the method of claim 19 in at least one of foodstuffs, animal feed, and pharmaceuticals.

21. Use of the protein, peptide and/or mixtures thereof obtained from the method of claim 19 in at least one of health food, food for the aged and reconvalescents, baby food, and functional foodstuffs.

22. Use of a the protein, peptide and/or mixtures thereof obtained from the method of claim 19 as a pharmaceutical for oral administration, preferably in capsule form.
